(19) United States
(12) Patent Application Publication
(10) Pub. No.: US 2023/0258785 A1
(43) Pub. Date: Aug. 17, 2023

(54) Reconfigurable Time of Flight Proximity Sensor with Near-Field and Far-Field Measurement Capabilities

(71) Applicant: Apple Inc., Cupertino, CA (US)

(72) Inventors: Shingo Mandai, Palo Alto, CA (US); Dong Zheng, Los Altos, CA (US); Tong Chen, Fremont, CA (US); Cristiano L Niclass, San Jose, CA (US)

(21) Appl. No.: 18/163,063

(22) Filed: Feb. 1, 2023

Related U.S. Application Data
(60) Provisional application No. 63/309,989, filed on Feb. 14, 2022.

(51) Int. Cl. G01S 7/487; G01S 7/4863; G01S 17/88

(52) U.S. Cl. CPC G01S 7/4876; G01S 7/4863; G01S 7/4873; G01S 17/88

(57) ABSTRACT

An electronic device may include a proximity sensor under a cover layer. The proximity sensor may include a light-emitter, such as an infrared light source, and a light-detector, such as an array of single-photon avalanche diodes (SPADs). The SPADs may measure light that has reflected from an external object. However, some of the light may be reflected by the cover layer, creating cross-talk. To distinguish between the cross-talk and signals from the external object, processing circuitry may histogram measurements from the SPADs. In particular, the processing circuitry may histogram near-field and/or far-field measurements into different histograms. The measurements may be weighted and/or gated prior to histogramming. In this way, cross-talk may be distinguished from the near-field and far-field signals.

This application claims the benefit of U.S. Provisional Patent Application No. 63/309,989, filed Feb. 14, 2022, which is hereby incorporated by reference herein in its entirety.

### FIELD

This relates generally to electronic devices and, more particularly, to electronic devices with proximity sensors.

### BACKGROUND

Electronic devices often include components that have sensors. For example, earbuds, cellular telephones, and other devices sometimes have light-based components such as light-based proximity sensors. A light-based proximity sensor may have a light source such as an infrared light-emitting diode and may have a light detector.

During operation, the light-emitting diode may emit light outwards from the electronic device. When the electronic device is near an external object, the emitted light may be reflected from the object and detected by the light detector. When the device is not in the vicinity of an external object, the light will not be reflected toward the light detector and only small amounts of reflected light will be detected by the light detector. However, some infrared light may reflect within the electronic device, thereby creating crosstalk. It may be difficult to determine whether light detected by the light detector is due to crosstalk or due to reflection from an external object.

### BRIEF DESCRIPTION OF THE DRAWINGS

FIG. 1 is a schematic diagram of an illustrative electronic device in accordance with an embodiment.

FIG. 2 is a perspective view of an illustrative electronic device having a proximity sensor in accordance with an embodiment.

FIG. 3 is a cross-sectional side view of an illustrative electronic device having a proximity sensor in accordance with an embodiment.

FIG. 4 is an illustrative diagram of a proximity sensor output over time in accordance with an embodiment.

FIG. 5 is a top view of an illustrative proximity sensor light detector having a SPAD pixel array in accordance with an embodiment.

FIGS. 6A and 6B are illustrative diagrams of a proximity sensor near-field output split into two different histograms in accordance with an embodiment.

FIG. 7 is an illustrative diagram of a proximity sensor output over time having variable bin sizes in accordance with an embodiment.

FIG. 8 is a diagram of illustrative proximity sensor circuitry that may be used to split a proximity sensor near-field output into multiple histograms in accordance with an embodiment.

FIG. 9 is a diagram of illustrative proximity sensor circuitry that may be used to split a proximity sensor near-field output into multiple histograms or a histogram with multiple resolutions in accordance with an embodiment.

FIG. 10 is a diagram of illustrative proximity sensor circuitry that may be used to provide feedback that allows weighting of the proximity sensor output in accordance with an embodiment.

FIG. 11 is a diagram of illustrative proximity sensor circuitry with saturation control and weighting that may be used to split a proximity sensor near-field output into multiple histograms in accordance with an embodiment.

FIG. 12 is an illustrative diagram of a proximity sensor output over time with variable integration times in accordance with an embodiment.

### DETAILED DESCRIPTION

Electronic devices may be provided with light-based components. The light-based components may include, for example, light-based proximity sensors. A light-based proximity sensor may have a light source such as an infrared light source and may have a light detector that detects whether light from the infrared light source has been reflected from an external object in the vicinity of an electronic device. Light sources may also be used as part of light-based transceivers, status indicator lights, displays, light-based touch sensors, light-based switches, and other light-based components. Illustrative configurations in which an electronic device is provided with a light-based component such as a light-based proximity sensor may sometimes be described herein as an example.

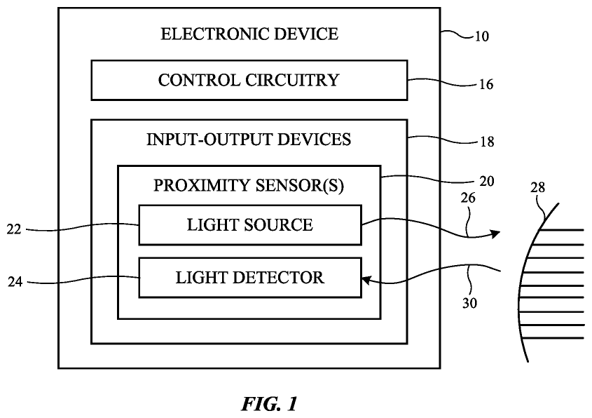

FIG. 1 is a schematic diagram of an illustrative electronic device of the type that may include a light-based proximity sensor. Electronic device 10 of FIG. 1 may be a computing device such as a laptop computer, a computer monitor containing an embedded computer, a tablet computer, a cellular telephone, a media player, or other handheld or portable electronic device, a smaller device such as a wrist-watch device, a pendant device, a headphone or earpiece device such as a set of wireless or wired earbuds, a device embedded in eyeglasses or other equipment worn on a user's head, or other wearable or miniature device, a television, a computer display that does not contain an embedded computer, a gaming device, a navigation device, an embedded system such as a system in which electronic equipment with a display is mounted in a kiosk or automobile, equipment that implements the functionality of two or more of these devices, an accessory (e.g., earbuds, a remote control, a wireless trackpad, etc.), or other electronic equipment.

As shown in FIG. 1, device 10 may include storage and processing circuitry such as control circuitry 16. Circuitry 16 may include storage such as hard disk drive storage, nonvolatile memory (e.g., flash memory or other electrically-programmable-read-only memory configured to form a solid-state drive), volatile memory (e.g., static or dynamic random-access-memory), etc. Processing circuitry in circuitry 16 may be used to control the operation of device 10. This processing circuitry may be based on one or more microprocessors, microcontrollers, digital signal processors, baseband processor integrated circuits, application specific integrated circuits, other circuits with logic circuitry for producing digital control signals, etc.

Circuitry 16 may be used to run software on device 10. The software may control the operation of sensors and other components in device 10. For example, the software may allow circuitry 16 to control the operation of light-based proximity sensors and to take suitable actions based on proximity data gathered from the light-based proximity sensors. As an example, a light-based proximity sensor may be used to detect when a wireless earbud is in the ear of a user or may be used to detect when other user (human) body parts are in the vicinity of an electronic device. Based on information on whether or not the earbud is in the ear of a user or is otherwise in a particular position relative to a user, the software running on control circuitry 16 may adjust audio output and/or media playback operations, may change the operation of communications functions (e.g., cellular telephone operations) for a paired cellular telephone or other additional device that is associated with the earbud, or may take other suitable action.

As another example, the light-based proximity sensor may be used to detect when a cellular telephone has been brought into close proximity with a user's head or other body part (e.g., within 1 cm, within 2 cm, within 5 cm, etc.). Based on information about whether or not the cellular telephone is brought up to a user's head or is in a particular position relative to a user, the software running on control circuitry 16 may adjust the brightness of a display within device 10, may deactivate the display, may deactivate any touch functions associated with the display, or may take other suitable action.

To support interactions with external equipment, circuitry 16 may be used in implementing communications protocols. Communications protocols that may be implemented using circuitry 16 include wireless local area network protocols (e.g., IEEE 802.11 protocols—sometimes referred to as WiFi®), protocols for other short-range wireless communications links such as the Bluetooth® protocol, cellular telephone protocols, near-field communications protocols, and other wireless communications protocols.

Device 10 may include input-output devices 18. Input-output devices 18 may be used to allow data to be supplied to device 10 and to allow data to be provided from device 10 to external devices. Input-output devices 18 may include touch screens, displays without touch sensor capabilities, buttons, joysticks, scrolling wheels, touch pads, key pads, keyboards, microphones, cameras, speakers, status indicators, light sources, audio jacks and other audio port components, light sensors, accelerometers, and other sensors, and input-output components. These components may include light-based components such as components with light sources. As shown in FIG. 1, device 10 may a light-based component such as one or more light-based proximity sensor(s) 20.

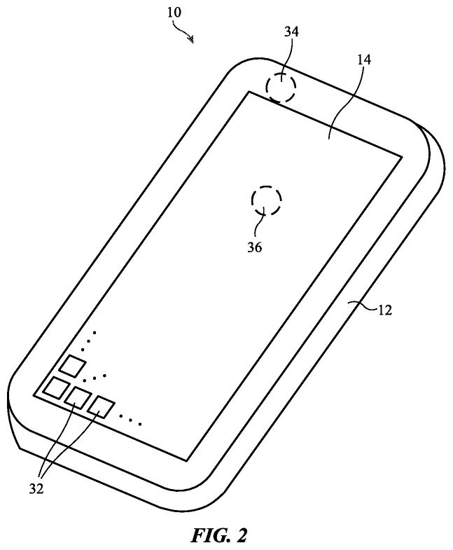

Proximity sensor 20 may include light source 22 and light detector 24. Light source 22 may emit light 26 that has the potential to be reflected from external objects such as object 28 (e.g., the ear or other body part of a user, inanimate objects, or other objects). Light detector 24 may measure how much of emitted light 26 is reflected towards device 10 as reflected light 30 and may therefore be used in determining whether an external object such as object 28 is present in the vicinity of device 10. Light 26 may be infrared light, visible light, or ultraviolet light (as examples). Infrared light is not visible to a user and is detectable by semiconductor infrared light detectors, so it may be desirable to form light source 22 from a component that emits infrared light. Light source 22 may be a light-emitting component such as a light-emitting diode or a laser diode (as examples). Proximity sensor 20 may output a proximity sensor reading (e.g., a proximity sensor output that is proportional to the distance between device 10 and object 28), and control circuitry 16 may monitor the proximity sensor reading and compare the proximity sensor reading to a predetermined threshold to detect proximity to external object 28. An example of device 10 is shown in FIG. 2.

As shown in FIG. 2, device 10 may include housing 12 and have front and rear faces and sidewalls that extend from the front face to the rear face. Display 14 may be formed in housing 12 on the front face of device 10. Display 14 may include pixels 32 that display images to a user of device 10. Display 14 may be a touch screen display that includes a touch sensor for gathering touch input from a user or display 14 may be insensitive to touch. A touch sensor for display 14 may be based on an array of capacitive touch sensor electrodes, acoustic touch sensor structures, resistive touch components, force-based touch sensor structures, a light-based touch sensor, or other suitable touch sensor arrangements. Display 14 may be include any desired display technology, and may be an organic light-emitting diode (OLED) display, a liquid crystal display (LCD), a microLED display, or any other desired type of display.

As discussed above in connection with FIG. 1, it may be desirable to include sensors, such as proximity sensors 20, in device 10. As shown in FIG. 2, proximity sensors 20 may be incorporated in device 10 at location 34 and/or at location 36. In particular, a proximity sensor formed at location 34 may be formed in a border region (i.e., inactive area) of display 14. The border region may be free from pixels 32 and may surround the active display area (i.e., the area that includes pixels 32) of display 14. If desired, display circuitry, such as driver circuitry, gate circuitry, or any other desired circuitry, may be formed within the border region, and an opaque layer, such as an ink layer or dark filter layer, may overlap the circuitry to obscure the circuitry from the view of the user. For example, display 14 may have a cover layer, such as a cover glass layer, that overlaps pixels 32 and the border region, and the opaque layer may be formed on the portion of the cover class that overlaps the border region.

When a proximity sensor (or other input-output device 18), is formed in the border region, the opaque layer may be removed or modified to accommodate the proximity sensor. However, this is merely illustrative. Proximity sensor 20 may operate through the opaque layer or any other layer, if desired. In use, proximity sensor 20 may include a light-emitter and a light-detector. The light-emitter may emit light (such as infrared light) through any overlapping layers (e.g., the display cover layer), and the light-detection may receive reflected light that has bounced off of an external target through the display cover layer.

Alternatively or additionally, proximity sensor 20 may be formed at location 36, which is under display 14. For example, proximity sensor 20 may be formed under the array of pixels 32. In one example, proximity sensor 20 may include a light-emitter and a light-detector. The light-emitter may emit light (such as infrared light) through the array of pixels (e.g., between adjacent pixels of the array of pixels), and the light-detection may receive reflected light that has bounced off of an external target through the array of pixels. However, this is merely illustrative. If desired, one or more pixels may be removed to accommodate underlying proximity sensor 20. Alternatively, proximity sensor 20 may be formed in the same substrate as pixels 32.

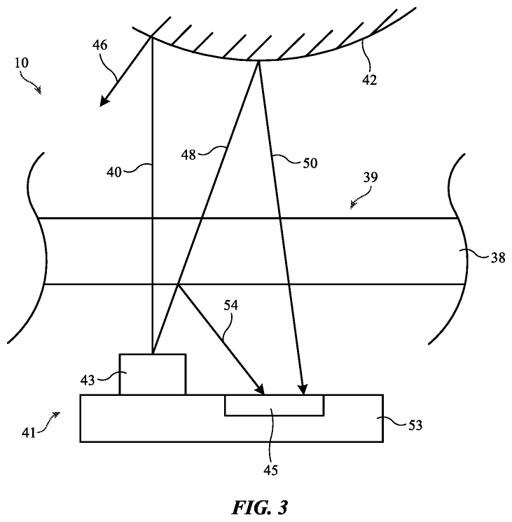

Although proximity sensor 20 has been shown on the front face of device 10, this is merely illustrative. Proximity sensors may be formed on the front face, the rear face, and/or any other face of device 10. Regardless of the location of proximity sensor 20, the proximity sensor may detect the proximity of objects from electronic device 10. An example of proximity sensor 20 detecting an external object is shown in FIG. 3.

As shown in FIG. 3, proximity sensor 41 may be formed in an interior region of device 10. In particular, proximity sensor 41 may include light source 43 and light detector 45 mounted on or in substrate 53. Substrate 53 may be the same substrate on which display pixels 32 are formed, a separate substrate, or any other desired portion of device 10. Although light source 43 and light detector 45 are shown on common substrate 43, this is merely illustrative. Light source 43 and light detector 45 may each be formed on any desired portion of device 10, such as separate substrates.

In some embodiments, light emitter 43 may be an infrared light emitter, such as an infrared light-emitting diode, or any other desired infrared light emitting device. In these embodiments, light detector 45 may be sensitive to infrared light. For example, light detector 45 may be an array of single-photon avalanche diode (SPAD) pixels that are each triggered and generate a signal in response to a single photon of infrared light. However, the use of an infrared light emitter and detector is merely illustrative. Light emitter 43 may emit light of any desired wavelength, such as visible, infrared, near-infrared, or ultraviolet, and light detector 45 may detect the same or a similar wavelength of light as the light emitted by light emitter 43.

Regardless of the wavelength of light emitted by light emitter 43, light emitter 43 may emit light 40 and 48 toward external target 42 through window 39 in cover layer 38. Cover layer 38 may be a display cover layer, such as the display cover layer that overlaps display 14 in FIG. 2, or may be a cover layer on another desired surface of device 10 (e.g., the rear surface of device 10). For example, window 39 may correspond to location 34 and/or location 36 in FIG. 2, if desired. Cover layer 38 may be optically transparent, transparent in the infrared spectrum, or have any other desired transparency. In one example, if light emitter 43 emits infrared light, cover layer 38 may be a glass, ceramic, sapphire, or other transparent layer that has a visible-light-blocking-infrared-transparent coating, such as an ink that passes infrared light while blocking visible light. However, this is merely illustrative. Any desired material and/or coatings may be used to form cover layer 38.

External target 42 may be exterior to device 10, and may be any desired object, and in some cases may be a portion of a user (e.g., a user's face, head, or hand). Once light 40 and 48 has reached target 42, the light may be respectively reflected as light 46 and light 50. Light 50 may be reflected back through cover layer 38 toward light detector 45, while light 46 may be reflected light that is reflected back toward device 10 away from light detector 45. In response to light 50, light detector 45 may generate a signal or signals representative of the amount and position of light 50. In turn, control and/or processing circuitry within device 10 may use the signal(s) to determine the proximity of external target 42 relative to proximity sensor 41 and therefore relative to device 10.

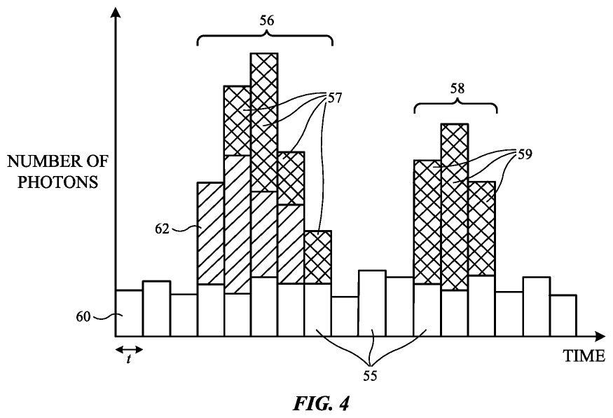

In addition to light 50 being reflected from external object 42, there may be stray light that reaches light detector 45. As shown in FIG. 3, a portion of light 48 emitted by light emitter 43 may be reflected by cover layer 38 as light 54. Light 54 may also reach light detector 45. Therefore, signals generated by light detector 45 may be made both in response to light 50 and light 54. Light 54 has caused undesirable cross-talk in this scenario, as light 50 is the portion with the relevant information regarding external target 42. Additionally, the amount and location of the cross-talk may be variable based on any foreign substances, such as dirt or smudges, on cover layer 38. The result of this cross-talk is shown in FIG. 4.

As shown in FIG. 4, the number of photons detected by light detector 45 may be plotted as a function of time in a histogram. In particular, each bar 60 in the histogram may correspond to the number of photons detected by light detector 45 over time period t. This may be referred to as a “bin” herein, and t may be referred to as the “bin size.” For example, the bins in FIG. 4 may have a bin size of less than 100 ps, less than 90 ps, less than 80 ps, more than 50 ps, or any other desired time duration. Portion 55 of each bin may correspond with a baseline amount of light (such as infrared light), or noise, that is detected by light detector 45 whether or not light emitted by light emitter 43 has been reflected back to light detector 45.

Portions 56 and 58 may correspond to target signals, or signals generated in response to light that has reflected off of an external target, such as target 42. In particular, portion 56 may correspond with a near-field target signal and portion 58 may correspond with a far-field signal (because the photons detected in portion 56 have returned to light detector 45 more quickly than the photons in portion 58, the target detected in portion 56 is closer than the target detected in portion 58). Portion 58 may include far-field signal 59 and baseline measurement 55 (e.g., known noise or error in light detector 45). As a result, for far-field signals, it may be straightforward for control circuitry or processing circuitry in device 10 to remove the baseline measurement 55 from the signals in portion 58 to determine the far-field signals 59.

Near-field portion 56, on the other hand, may include cross-talk, such as cross-talk caused by light 54 in FIG. 3. Specifically, light that has reflected from cover layer 38 may return to light detector 45 in a similar timeframe as light reflected from external objects close to device 10. As shown in FIG. 4, portion 56 may include near-field signal 57, baseline measurement 55, and cross-talk signal 62. Unlike in the case of far-field signals, it may be difficult to determine the near-field signal 57, due to the unknown amount of cross-talk (e.g., because the amount of cross-talk may be variable based on the presence of foreign substances on cover layer 38). Therefore, proximity sensor 41 may be designed to enable the determination of the amount of cross-talk and therefore a more accurate measurement of near-field signal 57.

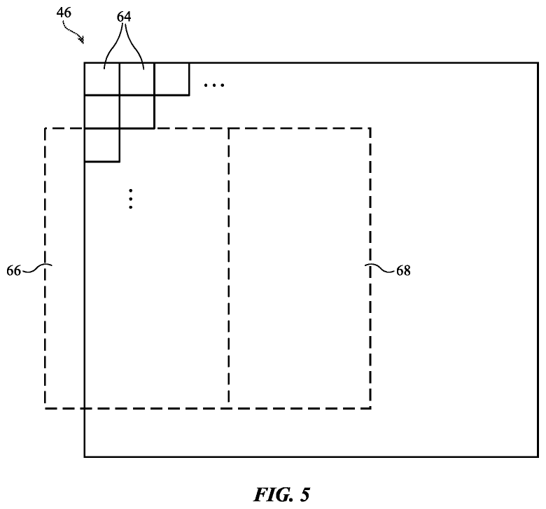

As shown in FIG. 5, light detector 45 of proximity sensor 41 may include a plurality of light-detectors 64. For example, light-detectors 64 may be a plurality of photodetectors or, as shown in FIG. 5, may include an array SPAD pixels 64 arranged in rows and columns. Each SPAD pixel 64 may generate current (i.e., a signal) in response to a single photon incident on the pixel, and a histogram, such as the histogram shown in FIG. 4 may be generated based on the timing of photons hitting the various SPAD pixels in the array.

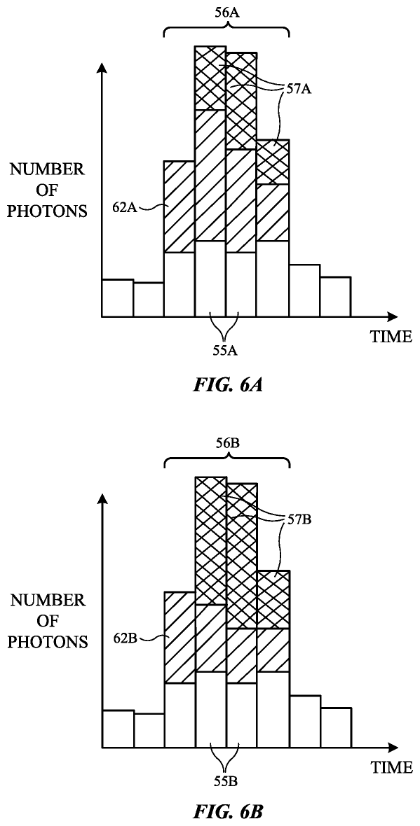

To determine the amount of cross-talk detected by light detector 45, the SPAD pixel array may be split into two different sections, section 66 and section 68. Section 66 may be in a location with higher cross-talk (e.g., because of the location of light emitter 43 relative to light detector 45 in FIG. 3, section 66 may be closer to light emitter 43). Section 68 may be in a location with lower cross-talk. The measurements from the SPADs in sections 66 and 68 may be split to determine the amount of cross-talk. For example, two near-field histograms may be generated, as shown in FIGS. 6A and 6B.

A first illustrative near-field signal histogram 56A that may be produced using the SPAD pixels in section 66 is shown in FIG. 6A. As shown in FIG. 6A, cross-talk 62A may constitute a larger portion of the signal above baseline 55A than near-field target signal 57A. This is in contrast to a second near-field signal histogram 56B that may be produced using the SPAD pixels in section 68 (shown in FIG. 6B). As shown in FIG. 6B, cross-talk 62B may constitute a smaller portion of the signal above baseline 55B than near-field target signal 57B.

As a result of generating histograms 56A and 56B separately, control circuitry and/or processing circuitry in device 10 may weigh the results of the two histograms to better approximate the actual near-field target signal. For example, control circuitry may apply a weight such that at least 60%, at least 70%, at least 80%, less than 90%, or any other desired percent of the near-field target signal 57 is generated by the SPAD pixels in region 68 (corresponding to histogram 56B). In this way, the near-field target signal may be more accurately measured, and near-field targets be more accurately detected by proximity sensor 41.

Although FIG. 5 only shows two sections 66 and 68, and FIGS. 6A and 6B show two histograms, this is merely illustrative. In general, the SPAD pixels array may be split into any desired number of sections to produce a corresponding number of histograms.

Although FIGS. 6A and 6B have been described as corresponding to locations 66 and 68 of the SPAD pixel array that forms light detector 45, this is merely illustrative. In general, any desired portions of the SPAD pixel array may be split into separate sections for determining cross-talk. Alternatively or additionally, the histograms in FIGS. 6A and 6B may be multiple histograms (e.g., each histogram corresponds with a shorter integration time than the histogram shown in FIG. 4). For example, if the histogram in FIG. 4 has an integration time of approximately 10 ms, the two histograms in FIGS. 6A and 6B may have an integration time of 5 ms or less (e.g., 1 ms each). This approach may be utilized after it is determined that a target is a near-field target and not a far-field target, as far-field target measurements will not be taken.

By having a shorter integration time for the SPAD pixel array, more data that corresponds with only the near-field signals may be obtained. If enough histograms are obtained in a short period of time, it may be assumed that the cross-talk and other ambient effects are relatively constant between the multiple histograms and that any differences between the histograms is due to the target moving. In this way, the near-field signal can be determined. If desired, taking multiple near-field measurements may be combined with generating multiple histograms for different portions of the SPAD pixel array (e.g., locations 66 and 68 of FIG. 5). In this way, more accurate near-field measurements may be taken.

Although FIGS. 6A and 6B show two histograms, this is merely illustrative. In general, any desired number of histograms may be produced to determine the near-field target signals based on the location of the SPAD pixels and/or by decreasing the integration time of the SPAD pixels.

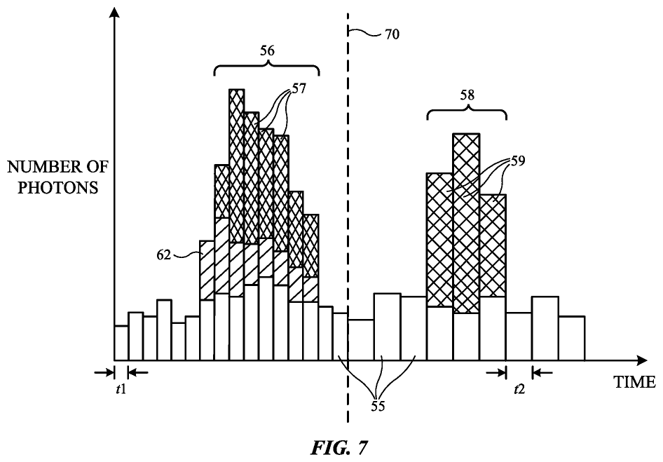

Alternatively or additionally to splitting the near-field target signal into two different histograms that may be weighted to more accurately determine the near-field target signal, the histogram bins may have varied size. An example of this arrangement is shown in FIG. 7.

As shown in FIG. 7, bins before the time indicated by line 70, which may include near-field signal bins 56, may have bin size t₁, which may be 50 ps, less than 50 ps, less than 60 ps, or any other desired bin size. Bins after time 70, which may include far-field signal bins 58, may have been size t₂, which may be 100 ps, greater than 50 ps, greater than 60 ps, or any other desired bin size. In this way, the bins corresponding to near-field target signal 56 may have a finer resolution, while the bins corresponding to far-field target signal 58 may have coarser resolution. The finer resolution for near-field target signal 56 may allow control circuitry in device 10 to obtain more near-filed target data, and to therefore more accurately determine the near-field target signal portion 57 (as opposed to cross-talk 62), while limiting the bandwidth needed for the entire histogram with the broader resolution for far-field signal 58.

Time 70 (the demarcation between the fine and coarse bins) may be moved as desired based on the target being measured. For example, time 70 may be moved to ensure that the near-field signal is entirely within the time prior to time 70. Alternatively or additionally, time 70 may be moved past far-field signal if there is an application that requires more precise proximity detection or that requires the detection of multiple far-field targets. However, these examples are merely illustrative. In general, time 70 may be moved to any desired time relative to the near-field and far-field signals.

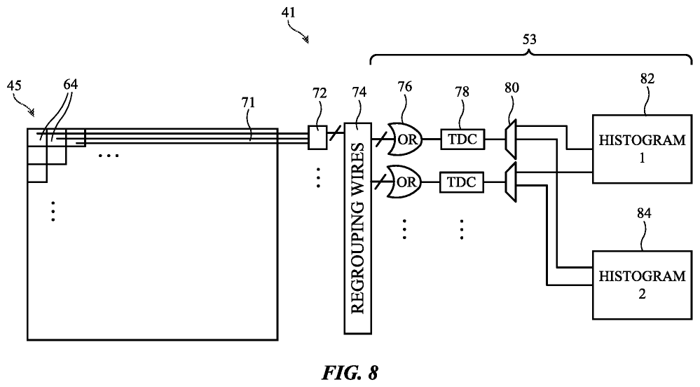

If desired, finer bins may be used for the near-field measurements (as described in FIG. 7) and may be used in combination with one or both of the proximity sensor measurements discussed in connection with FIGS. 6A and 6B (generating different histograms for different portions of the SPAD pixel array, or having a short integration time to generate multiple near-filed histograms in the time domain). In general, the multiple histograms based on SPAD pixel location (FIGS. 5, 6A, and 6B), the multiple histograms based on shorter integration time (FIGS. 6A and 6B), and the finer bins for near-field measurements (FIG. 7) may be dynamically activated based on the detected external object. For example, if a far-field target is detected, a conventional histogram (like FIG. 4) may be produced, while if a near-field target is detected, one or more of the histograms in FIGS. 6A, 6B, and 7 may be produced. Used in combination, these proximity sensor measurements may improve the near-field measurements by reducing the effects of cross-talk in the near-field measurements. Regardless of which of these near-field measurements are used, a diagram showing illustrative architecture of proximity sensor 41 is shown in FIG. 8.

As shown in FIG. 8, proximity sensor 41 may include light detector 45, which, as discussed above in connection with FIG. 5, may include an array of SPAD pixels 64 arranged in rows and columns of pixels. Each row of SPAD pixels 64 may be coupled to pulse shaper circuit 72 and regrouping wires 74 via lines 64. For example, regrouping wires 74 may group neighboring SPAD pixels. This grouping may include a 3×4 grouping of SPAD pixels, 8×8 grouping of SPAD pixels, 4×4 grouping of SPAD pixels, 2×2 grouping of SPAD pixels, or any other desired grouping of neighboring SPAD pixels. The signals leaving regrouping wires 74 may be carried on any desired number of lines. Once the signals have been grouped, the grouped signals proceed to circuitry 53, which routes the signals into respective histograms for processing.

In particular, the signals that reach circuitry 53 first pass through OR circuitry 76, and the signals that pass through OR circuitry 76 are converted into from the time domain to the digital domain via time-to-digital converter (TDC) 78. Because the signals leaving TDC 78 are in the time domain, digital multiplexer (MUX) 80 may then route the digital signals leaving each TDC 78 to one of histogram 1 (82) or histogram 2 (84). As an example, histogram 1 (84) may correspond with histogram 56A of FIG. 6A and histogram 2 (84) may correspond with histogram 56B of FIG. 6B.

By having each OR circuit 76 receive signals from a subset of the SPAD pixel array, such as from 12 SPAD pixels, from less than 16 SPAD pixels, from less than 32 SPAC pixels, or any other desired subset of the pixel array, more target information may pass to TDCs 78 and eventually to histograms 82 and 84 than in conventional ambient light sensors. This may allow the control circuitry to better determine an amount of cross-talk in the near-field signals, as the signals that are taken at the same time, but at different locations in the SPAD array can be compared.

Although FIG. 8 shows two histograms 82 and 84, this is merely illustrative. In general, the output of light detector 45 may be split into any number of desired histograms.

In use, control circuitry in device 10 may dynamically search for a far-field signal in the output of light detector 45. If a far-field signal is found, a single histogram may be used to determine the far-field signal, due to the lack of cross-talk interference as described above in connection with FIG. 4. On the other hand, if no far-field target is detected, the control circuitry may use circuitry 53 (and specifically digital MUXs 80) to split the output into two or more histograms, which may be used to determine whether a near-field signal is present. If desired, however, the signal may be split into multiple histograms at any desired time. For example, multiple histograms may be used if a far-field target is detected.

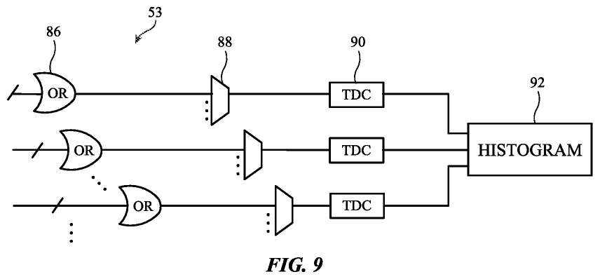

An alternative configuration for circuitry 53 is shown in FIG. 9. While the OR circuits in FIG. 8 may receive signals from each pixel in a 3×4 or other sub-array of SPAD pixels, OR circuits 86 in FIG. 9 may receive signals from smaller sub-arrays of SPAD pixels, such as 2×2 or 4×4 sub-arrays of SPAD pixels. The output of OR circuits 86 may then be inputted into MUXs 88, which may include inputs from the groups of sub-arrays. MUXs 88 may then flexibly pass these signals to TDCs 90, which may in turn pass the signals to one of more histograms 92. In this way, any desired group of pixels, whether adjacent to one another or not, may be used in forming one of the histograms used by control circuitry to determine the near-field target signal. In particular, the groups of pixels that form each histogram may be adjusted based on return signals detected by light detector 45. In one example, groups of SPAD pixels that are receiving more protons than other groups of pixels may be grouped together, so that the signals from those pixels may be routed to a single histogram for processing. This may allow for accurate measurements despite mechanical tolerances during manufacturing and/or drift of components during operation.

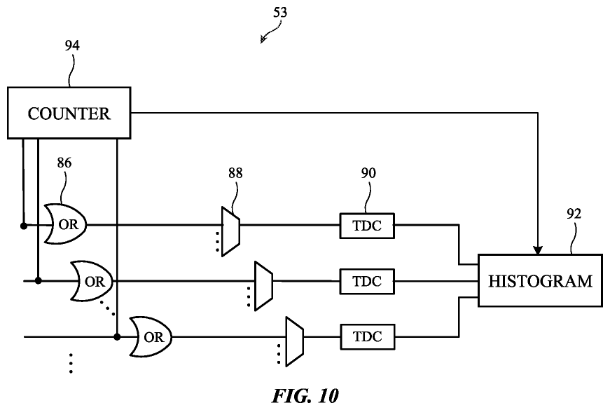

A second alternative configuration for circuitry 53 is shown in FIG. 10. In particular, if desired, circuitry 53 may weigh the output of different SPAD pixels based on the location of an external target. For example, some of the SPAD pixels may exhibit a low signal-to-noise ratio (SNR), while some of the SPAD pixels may exhibit a high SNR. Because some SPAD pixels may receive more signal than others, it may be desirable to weigh the output of the SPAD pixels based on the amount of signal they receive. Therefore, as shown in FIG. 10, counter 94 may be incorporated into circuitry 53. Counter 94 may determine when each output from the SPAD pixel array passes counter 94 and assign a value to a group of pixels based on the signal produced by each pixel.

For example, the counter may assign values to a group of 64 SPAD pixels (although any desired group size may be used) that have generated the most signals in response to an external object. Within that group of 64 pixels, each pixel may receive a value based on its individual contribution. Control circuitry within device 10 may then weight the output of TDCs 90 based on the value assigned to the pixel from which the output originated. In this way, circuitry 53 may keep track of the outputs of SPAD pixels having different characteristics, and the control circuitry may apply weights to those outputs based on the SPAD pixel characteristics. This process may be dynamic, as counter 94 may assign values to different groups of pixels and to the individual pixels within those groups of pixels based on the signal generated by the pixels (e.g., as an external target moves, different pixels will generate more signal). This may allow for more accurate measurements of either or both of near-field and far-field target measurements.

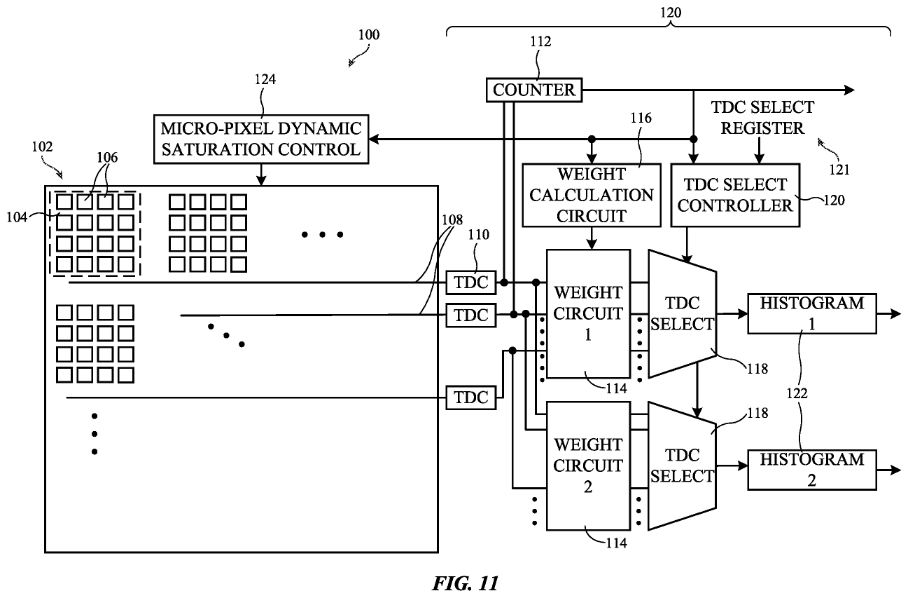

An illustrative example of using a proximity sensor with an array of multiple groups of SPAD pixels is shown in FIG. 11. As shown in FIG. 11, proximity sensor 100 (which may be used as proximity sensor 45) may include light detector 102, which may include an array of micropixels 104. Each micropixel 104 may include a plurality of SPAD pixels 106. For example, light detector 102 may include an array of 16 micropixels, each of which includes 16 SPAD pixels. However, this is merely illustrative. In general, light detector 102 may include any desired number of micropixels and/or SPAD pixels per micropixel.

SPAD pixels 106 in each micropixel 104 may generate signals in response to light that has been reflected off of an external target. These signals may be output over lines 108 to circuitry 120. Circuitry 120 may be a portion of proximity sensor 100 (e.g., processing circuitry within proximity sensor 100), or may be a portion of control circuitry or processing circuitry, such as control circuitry 16 of FIG. 1.

The signals produced by each micropixel 104 are converted from the time domain to the digital domain via time-to-digital converters (TDC) 110. After being converted to the digital domain, the signals may be weighted using weight circuits 114. Weight circuits 114 may weight the signals based on outputs from weight calculation circuit 116. Weight calculation circuit 116 may base the appropriate weights on outputs from counter 112. Counter 112 may be similar to counter 94 of FIG. 10, and may determine when each output from the SPAD pixel array passes counter 112 and assign a value to a group of pixels based on the signal produced by each pixel.

For example, the counter may assign values to a group of 16 SPAR pixels (e.g., each micropixel 104, although any desired group size may be used) that have generated the most signals in response to an external object. Within that group of 16 pixels, each pixel may receive a value based on its individual contribution.

Weight calculation circuit 116 may determine the appropriate weights based on the values assigned by counter 112. Weight circuits 114 may then apply the weights to the outputs of TDCs 110.

Because the signals leaving weight circuits 114 are in the time domain, TDC select multiplexers (MUXs) 118 may then route the digital signals leaving weight circuits 114 to histograms 122. TDC select MUXs 118 may route the digital signals based on outputs of TDC select controller 120, which may determine the appropriate signal routing based on outputs from counter 112 and information from TDC select register 121, which may be a look-up table or other register.

Although FIG. 11 shows two histograms 122, this is merely illustrative. In general, the output of light detector 102 may be split into any number of desired histograms.

Micropixel dynamic saturation control 124 may also be included in circuitry 120. In particular micropixel dynamic saturation control 124 may selectively activate or deactivate SPADs 106 within micropixels 102 to change the saturation of each micropixel 102. For example, if circuitry 120 determines that one of micropixels 102 is more susceptible to cross-talk, some or all of SPADs 106 within that micropixel 102 may be deactivated (e.g., turned off to prevent the SPADs from generating measurements in response to light). In this way, micropixel dynamic saturation control 124 may adjust micropixels 102 as needed.

In use, control circuitry in device 10 may dynamically search for a far-field signal in the output of light detector 102. If a far-field signal is found, a single histogram may be used to determine the far-field signal, due to the lack of cross-talk interference as described above in connection with FIG. 4. On the other hand, if no far-field target is detected, the control circuitry may use circuitry 120 (and specifically TDC select MUXs 118) to split the output into two or more histograms, which may be used to determine whether a near-field signal is present. If desired, however, the signal may be split into multiple histograms at any desired time. For example, multiple histograms may be used if a far-field target is detected.

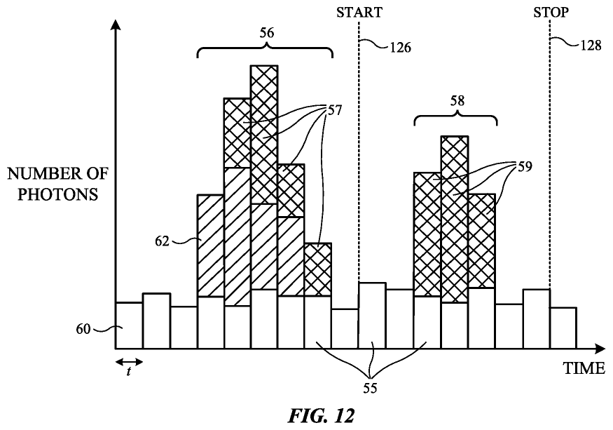

Using counter 112 of FIG. 11 or counter 94 of FIG. 10 may allow processing circuitry to integrate signals from the light detector only during periods of interest. For example, if a far-field target is detected, the counter may gate the integration time during only the time in which the far-field signals are received. An illustrative example of a histogram showing a gated integration window is shown in FIG. 12.

As shown in FIG. 12, integration may begin at time 126 and stop at time 128. In this way, far-field signals 58 may be integrated, while near-field signals 56 are not. However, the integration window of FIG. 12 is merely illustrative. If a near-field target is detected, the integration window may extend from prior to near-field signals 56 to just after near-field signals 56.

Although FIG. 12 shows an integration window, this is merely illustrative. If desired a counter circuit may be used to create an integration threshold. For example, all of the signals received after the threshold may be integrated, while the signals received before the threshold may not be integrated. Alternatively, all of the signals received before the threshold may be integrated, while the signals received after the threshold may not be integrated. In general, the counter circuit may be used to adjust the time period(s) for integration in any desired manner.

The foregoing is merely illustrative of the principles of this invention and various modifications can be made by those skilled in the art without departing from the scope and spirit of the invention. The foregoing embodiments may be implemented individually or in any combination.

What is claimed is:

1. An electronic device, comprising:
a proximity sensor that generates near-field measurements and far-field measurements, wherein the proximity sensor comprises a light detector having an array of SPAD pixels, and wherein the proximity sensor is configured to split the near-field measurements into a first group of near-field measurements and a second group of near-field measurements based on respective locations of the SPAD pixels that produced the first and second groups of near-field measurements; and
processing circuitry that receives the near-field measurements and the far-field measurements from the proximity sensor, wherein the processing circuitry is configured to produce a first histogram based on the first group of near-field measurements and is configured to produce a second histogram based on the second group of near-field measurements.

2. The electronic device defined in claim 1, wherein the proximity sensor is configured to generate the near-field measurements over a first integration time and wherein the proximity sensor is configured to generate the far-field measurements over a second integration time that is greater than the first integration time.

3. The electronic device defined in claim 2, wherein the proximity sensor is configured to generate the near-field measurements without generating far-field measurements in response to the processing circuitry determining the presence of a near-field external object.

4. The electronic device defined in claim 1, wherein the array of SPAD pixels comprises a first group of the SPAD pixels and a second group of the SPAD pixels, wherein the first group of the SPAD pixels are configured to produce the first group of near-field measurements and the second group of the SPAD pixels are configured to produce the second group of near-field measurements.

5. The electronic device defined in claim 1, wherein processing circuitry is further configured to generate a third histogram of the far-field measurements, wherein the first and second histograms have first bin sizes and the third histogram has second bin sizes, and wherein the second bin sizes are smaller than the first bin sizes.

6. The electronic device defined in claim 5, wherein the processing circuitry is configured to adjust sizes of the first and second histograms in response to measurements by the proximity sensor.

7. The electronic device defined in claim 1, wherein the proximity sensor comprises:
a plurality of micropixels, wherein each of the micropixels comprises a plurality of individually addressable SPADs.

8. The electronic device defined in claim 7, wherein the processing circuitry is further configured to adjust a saturation of the plurality of micropixels.

9. The electronic device defined in claim 1, wherein the processing circuitry is configured to weight the near-filed and far-field measurements based on a location of an external object.

10. An electronic device, comprising:
a proximity sensor comprising a plurality of micro-pixels configured to generate far-field and near-field measurements; and
processing circuitry comprising a counter circuit, wherein the processing circuitry is configured to weight the near-field and the far-field measurements based on an output of the counter circuit and to produce first and second histograms of the weighted near-field measurements and the weighted far-field measurements.

11. The electronic device defined in claim 10, wherein the counter circuit is gated based on a time period during which the far-field measurements are generated.

12. The electronic device defined in claim 11, wherein the time period is a window of time over which the far-field measurements are integrated, and wherein the processing circuitry is configured to not integrate signals outside of the window.

13. The electronic device defined in claim 11, wherein the time period is a threshold, wherein the far-field measurements are integrated within the threshold, and wherein the processing circuitry is configured to not integrate signals outside of the threshold.

14. The electronic device defined in claim 11, wherein the processing circuitry is configured to integrate over a time period that includes the far-field measurements and that does not include the near-field measurements.

15. The electronic device defined in claim 10, wherein each micropixel of the plurality of micropixels comprises a plurality of individually addressable SPADs.

16. The electronic device defined in claim 15, wherein the processing circuitry is further configured to adjust a saturation of the plurality of micropixels.

17. The electronic device defined in claim 16, wherein the processing circuitry is configured to adjust the saturation of the plurality of micropixels by adjusting the SPADs in response to an output of the counter circuit.

18. An electronic device, comprising:
a proximity sensor comprising a SPADs configured to generate far-field measurements and near-field measurements; and
processing circuitry comprising a counter circuit, wherein the processing circuitry is configured to weight the far-field measurements and the near-filed measurements based on an output from the counter circuit, and wherein the processing circuitry is configured to generate first and second histograms based on the weighed far-field measurements and the weighted near-field measurements.

19. The electronic device defined in claim 18, wherein the first and second histograms comprise histograms of only the near-field measurements.

20. The electronic device defined in claim 18, wherein the first and second histograms comprise histograms of only the far-field measurements.
